(19) United States
(12) Patent Application Publication
(10) Pub. No.: US 2013/0268340 A1
(43) Pub. Date: Oct. 10, 2013

(54) Method and System for Geographically Mapping Financial Transaction Data

(71) Applicants: Jaime Colon, New York, NY (US); David Greenspan, Staten Island, NY (US)

(72) Inventors: Jaime Colon, New York, NY (US); David Greenspan, Staten Island, NY (US)

(73) Assignee: AMERICAN EXPRESS TRAVEL RELATED SERVICES COMPANY, INC., New York, NY (US)

(21) Appl. No.: 13/443,100

(22) Filed: Apr. 10, 2012

(51) Int. Cl. G06Q 40/00; G06Q 30/02

(52) U.S. Cl. 705/14.25; 705/35; 705/14.1

(57) ABSTRACT

A method of geographically mapping financial transactions may include receiving transaction data associated with an account and a financial transaction, and mapping an indicator representing the financial transaction based on the transaction location. The mapping of the financial transactions provides the account holder with a visual summary of financial transactions and may be used to detect various patterns or potential fraud. The method may include organizing financial transactions according to a transaction status, and setting a characteristic of the indicator based on the transaction status. In addition, the method may include correlating merchant data with the geographic location of the transaction occurrence, where an invoice address of the merchant data is not the same as the transaction location, and where the transaction location is determined using an address or latitude-longitude coordinates. Further, the merchant data may be associated with a public name of a merchant.

### FIELD OF DISCLOSURE

The present disclosure generally relates to transaction account management. More particularly, the disclosure relates to geographically mapping financial transactions associated with accounts.

### BACKGROUND

A user may perform multiple transactions with one or more merchants. Such transactions may include financial transactions performed using an account, such as a credit card, a debit card, a pre-paid card etc. Over a period of time, the user may tend to forget data pertaining to the transactions performed with the one or more merchants. The user may review a transactions record associated with the account to check for the transactions performed. For example, the user may review the transaction record online or may review transaction statements received from a financial institution managing the account. The transactions record may include data entries representing the transactions. Due to space constraints, the data entries are often written in short forms or in codes that may include a transaction ID, merchant ID, a merchant name, the merchant's address, combination thereof and the like. For example, a data entry might be an alphanumeric code comprising transaction ID, the merchant ID, a merchant name, a location and/or a store. The user may not be able to easily understand such entries. As a result, the user may not recognize the transactions represented by the data entries. Also, the user may not be able to recollect all the transactions or correlate the transactions with the date entries. Consequently, the user may not be able to recognize the transactions timely and prevent fraud. Also, getting information about the transactions may be cumbersome.

### SUMMARY OF THE DISCLOSURE

A method of geographically mapping financial transactions may include receiving transaction data associated with an account (where the transaction data includes data on a financial transaction) and mapping an indicator representing a financial transaction based on the transaction location. The mapping of the financial transactions provides the account holder with a visual summary of financial transactions and may be used to detect various patterns or potential fraud.

Further, the method may include organizing the financial transactions according to a transaction status, and setting a characteristic of the indicator based on the transaction status. The characteristic of the indicator may be at least one of color, size, or shape. In addition, the method may include correlating merchant data with the geographic location of the transaction occurrence, where an invoice address of the merchant data is not the same as the transaction location, and where the transaction location is determined using an address or latitude-longitude coordinates. Further, the merchant data may be associated with a public name of a merchant. By mapping the transaction location instead of a merchant's invoice address, and by providing a merchant's public name, an account holder receives more information helpful for determining whether a transaction is accurate. An invoice entry on a financial statement often includes a detailed description which includes an unfamiliar merchant name or address. The account holder may question the transaction if the details are not familiar or do not trigger recollection of the transaction. For example, the account holder may receive a charge for Acme, Inc, while the transaction occurred at a location under a recognizable public name. By providing a visual indicator for the transaction location including the public name, the account holder is more likely to recollect the transaction and not need to connect to a financial institution to dispute an unrecognized transaction.

An additional benefit of geographically mapping financial transactions of an account holder is fraud detection. The account holder is more likely to review transactions that occurred outside of a typical area. This unusual activity may be undetected by the account holder if only provided in a detailed text statement. Further, the computer-based system can draw attention to transaction occurring outside the normal activity area by changing a characteristic of one of the map indicators.

In various embodiments, the method includes receiving a review request from an account holder, where the review request includes an account holder review of a merchant. A system certifies that the account holder has at least one financial transaction at the merchant and generates a transaction certificate, and sends a certified account holder review to one or more social networks or websites, where the certified account holder review includes the review request and the transaction certificate. The certification of the review request enhances the credibility of the account holder review by confirming that the account holder has conducted at least one transaction at the reviewed merchant. The certified account holder review may further include a date of the financial transaction that occurred between the account holder at the merchant. If the account holder has conducted multiple transactions at the merchant, then the account holder may have the option to certify and include multiple transaction dates.

Further features and advantages of the present disclosure as well as the structure and operation of various embodiments are described in detail below with reference to the accompanying drawings.

### BRIEF DESCRIPTION OF THE DRAWINGS

The features and advantages of the present disclosure will become more apparent from the detailed description set forth below when taken in conjunction with the drawings, in which like reference numbers indicate identical or functionally similar elements. Additionally, the left-most digit of a reference number identifies the drawing in which the reference number first appears.

FIG. 1 is an overview of an exemplary computer-based system for geographically mapping transactions, in accordance with various embodiments of the present disclosure;

FIG. 2 is a flowchart illustrating one example process for geographically mapping a transaction, according to an embodiment of the present disclosure;

FIG. 3 is a flowchart illustrating one example process for sharing account holder review with other websites, according to an embodiment of the present disclosure;

FIG. 4 is an exemplary user interface view illustrating a transaction statement, according to an embodiment of the present disclosure;

FIG. 5 is an exemplary user interface view illustrating mapping of indicators representing financial transactions to a map, according to an embodiment of the present disclosure;

FIG. 6 is an exemplary user interface view illustrating receiving the account holder review through the map, according to an embodiment of the present disclosure;

FIG. 7 is an exemplary user interface view illustrating a portal of the account holder in a social networking site, according to an embodiment of the present disclosure; and

FIG. 8 is a block diagram of an exemplary computer system, according to an embodiment of the present disclosure.

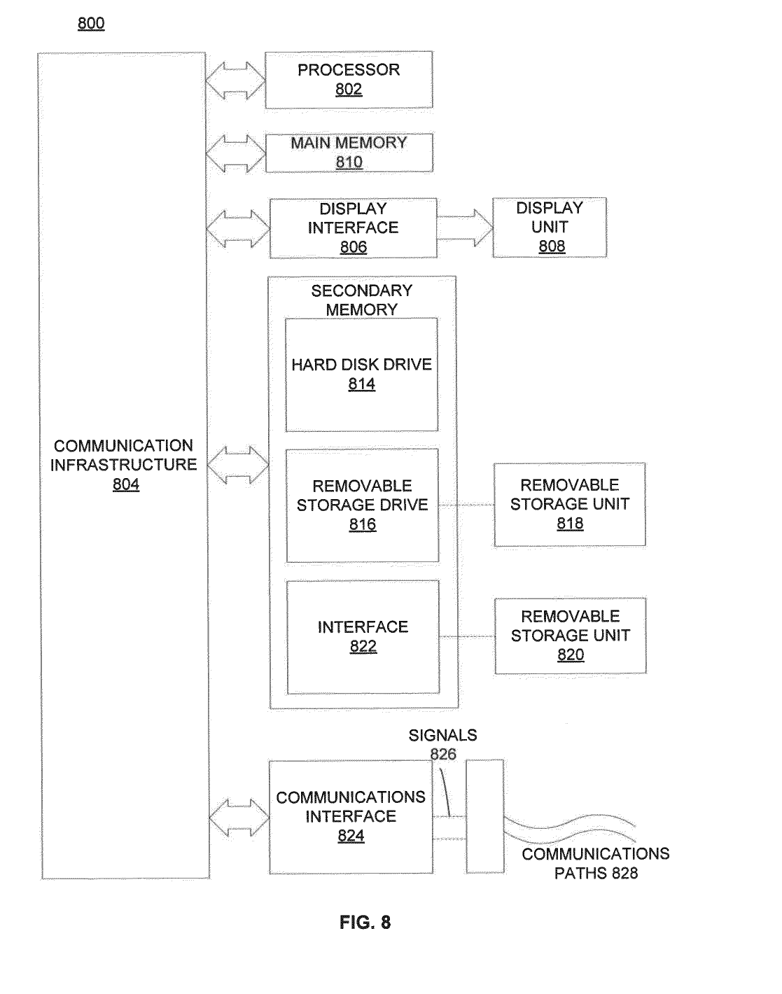

### DETAILED DESCRIPTION

The detailed description of exemplary embodiments of the disclosure herein makes reference to the accompanying drawings and figures, which show the exemplary embodiments by way of illustration only. While these exemplary embodiments are described in sufficient detail to enable those skilled in the art to practice the disclosure, it should be understood that other embodiments may be realized and that logical and mechanical changes may be made without departing from the spirit and scope of the disclosure. It will be apparent to a person skilled in the pertinent art that this disclosure can also be employed in a variety of other applications. Thus, the detailed description herein is presented for purposes of illustration only and not of limitation. For example, the steps recited in any of the method or process descriptions may be executed in any order and are not limited to the order presented.

The phrases consumer, customer, user, account holder, cardmember or the like shall include any person, entity, government organization, business, machine associated with a transaction account, buys merchant offerings offered by one or more merchants using the account and/or who is legally designated for performing transactions on the account, regardless of whether a physical card is associated with the account. For example, the cardmember may include a transaction account owner, an transaction account user, an account affiliate, a child account user, a subsidiary account user, a beneficiary of an account, a custodian of an account, and/or any other person or entity affiliated or associated with a transaction account.

As used herein, a “merchant” is any entity that is a provider, broker and/or any other entity in the distribution chain of products or services. For example, a merchant may be a retail store, a travel agency, a restaurant, a hotel, a service provider, an on-line merchant, and the like. The term “merchant information” for a merchant may include, for example, a merchant name, a merchant address, a merchant identifier and the like.

The term “merchant offerings” is used to represent products, services and the like. The merchant offerings may refer to any kind of product, or services offered to a customer. Examples of products may include consumer devices, automobiles, clothing, food and/or the like. Examples of services may include financial services, banking services, travel-related services and/or the like.

The term “account” may refer to, without limitation, a deposit account, credit cards, debit cards, pre-paid cards, charge cards, gift cards, and the like. In one example, the account may be provided by a financial institution. In another example, the account may be provided by issuers such as, for example, American Express®. The account information may include details such as, an account number, a type of the account, an expiry date of the account, an account holder name, an account holder address, etc.

The term “transaction” used herein in the current disclosure may refer an act of the account holder buying merchant offerings for a financial consideration. The term “financial consideration” may refer to payments made using the account.

The term “transaction data” may include information such as, transaction amount, merchant data, transaction type, transaction date, transaction time, account information, account holder information, merchant offerings, a transaction currency and/or the like. The term “merchant data” may include merchant name, merchant address, merchant registration data and/or the like. The account holder information may include, for example, an account holder name, an account holder address, and/or the like.

The present disclosure is now described in terms of an exemplary system, in which various embodiments of the present disclosure would be implemented. It will be apparent to one skilled in the relevant art(s) that the above disclosure has been described by way of illustration and not limitation, and that the present disclosure may be implemented in alternate embodiments.

The present disclosure is directed to geographically mapping financial transactions associated with an account. A computer-based system that maintains the account transaction data may analyze transaction data in the account. Using the transaction data, the computer-based system may generate indicators representing financial transactions. The computer-based system may map the indicators to a map. The map broadly illustrates the financial transactions performed at corresponding transaction locations. The map also provides transaction details at corresponding transaction locations. For example, the map may display the merchant name, the transaction location, the transaction amount, the transaction date, or any other transaction data. The map may aid the account holder in recognizing the transactions performed at the transaction locations. An example system is described below that geographically maps the transactions into a map.

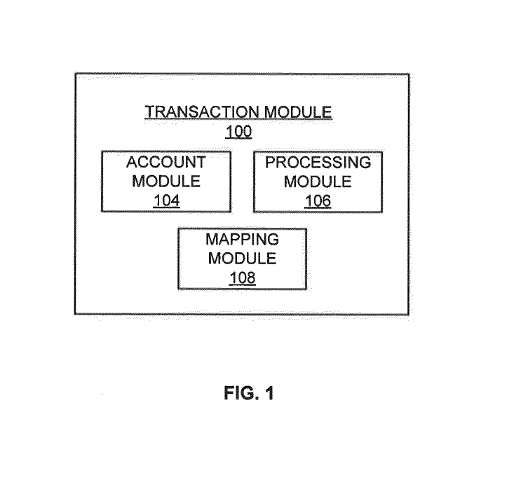

FIG. 1 is an overview of an exemplary transaction module 100 for mapping financial transactions, in accordance with various embodiments of the present disclosure. Transaction module 100 geographically maps financial transactions. Transaction module 100 may also enable sharing of an account holder review on a website or a social network. In the current example implementation, transaction module 100 includes an account module 104, a processing module 106, and a mapping module 108.

Account module 104 receives transaction data pertaining to a transaction performed by an account holder with a merchant using an account. In one embodiment, account module 104 may receive the transaction data from the merchant. In another embodiment, account module 104 may receive the transaction data from a financial institution or an issuer providing the account. In yet another embodiment, account module 104 may receive the transaction data from a third party maintaining the account. Account module 104 may present the transaction data to the account holder.

Processing module 106 may extract a merchant name associated with the transaction by processing the transaction data received by account module 104. In one embodiment, the merchant name may be present in the transaction data. Otherwise, processing module 106 may determine the merchant name using, for example, a merchant identifier present in the transaction data. The merchant identifier may be a merchant provided by the financial institution or the issuer maintaining the account. The merchant name extracted or determined by processing module 106 may be a publicly used name and/or a corporation name of the merchant. Processing module 106 may determine whether the merchant name is a publicly used name and/or a corporation name. In one embodiment, processing module 106 may retrieve information associated with the merchant name in an internal database (not shown) to determine whether the merchant name is a publicly used name and/or a corporation name. In another embodiment, processing module 106 may retrieve information associated with the merchant name from an external source. If the merchant name is not a publicly used name, processing module 106 may determine a public name of the merchant. For example, processing module 106 may determine that a public name of a merchant is “XYZ apparels”, while the corporation name of the merchant is “AAA Clothing”, Processing module 106 may associate the public name of the merchant with the merchant data. Associating the public name of the merchant with the merchant data enables the account holder to recall transaction details more easily, as the account holder may be more familiar with the public name of the merchant.

Processing module 106 may determine the transaction location of a financial transaction by processing the transaction data. The transaction location may be, without limitation, a merchant address, the account holder residence or workplace or any place the account holder performs the transaction. The transaction location may be present in the transaction data in a form of the merchant address, point of sale (POS) location, an IP address of a data processing system and the like. In some embodiments, the merchant address may not correspond to the transaction location, for example, when the account holder performs the transaction at a POS terminal deployed by the merchant, but the merchant address on the transaction record corresponds to the headquarters address of the merchant. Processing module 106 may determine whether the merchant address corresponds to the transaction location. For example, processing module 106 may process the point of sale location information, IP address of system or the like to determine an address of the transaction location or geographical coordinates of the transaction location. If the merchant address corresponds to the location in geographical coordinates (latitude-longitude coordinates), processing module 106 may set the merchant address as the transaction location. Otherwise, processing module 106 may set the location obtained through the processing as the transaction location. Other techniques of determining the one or more transaction locations are contemplated herein. Processing module 106 may correlate the transaction location with the merchant data. In sonic embodiments, processing module 106 may augment the transaction data with the public name of the merchant, and the transaction location.

Processing module 106 may also retrieve account holder data associated with the account holder. The account holder data may include the account number, an account holder address, and demographic information of the account holder. In various embodiments, the account holder data may also include the account holder's social media attributes, such as interests, “likes”, recommendations, locations visited, network connections, and the like. Processing module 106 may communicate the transactions data and the account holder data to mapping module 108 to geographically map the financial transactions. In one embodiment, processing module 106 may communicate the transaction data through an application program interface (API) of mapping module 108. Other techniques for communicating the transaction data to the mapping module 108 are contemplated herein.

Mapping module 108 may receive the transaction data and the account holder information. Mapping module 108 may be a mapping tool that provides computer represented maps (hereinafter used as “maps”). Mapping module 108 may also provide capabilities to customize the maps. In various embodiments, mapping module 108 may identify geographic locations corresponding to the transaction locations on the map. Using the transaction location, mapping module 10$ geographically map indicators representing the financial transactions. For example, mapping module 108 may place an indicator relative to a transaction location in the map. The indicator may refer to visual pointers pointing the transaction location in the map. The indicator, for example, may include a push pin, an indicative balloon, indicative arrows, a text balloon, a circle, a triangle, any other geometrical or non-geometrical shape, or any combination thereof.

Mapping module 108 may also display a subset of, or all of, the transaction data relative to the indicator automatically or in response to an account holder request. In one embodiment, mapping module 108 may display the merchant data, the merchant offerings associated with the transaction, the transaction amount, discount applied if any, and the like, relative to the indicator. Mapping module 108 may also display current discount offers and/or advertisements relative to the indicator. Mapping module 108 may receive the discount offers and/or advertisements from different merchants. The current discount offers and advertisements may be populated based on the location of a merchant offering the discount and/or the advertisements relative to the transaction location. In one embodiment, the discounts may be provided by the merchant based on a prior transaction. Advertisements about merchant offerings may be provided by the merchant. In the various embodiments, the discount offers and/or advertisements may be provided by merchants that the account holder has previously conducted a transaction, or by merchants that the account holder has not conducted a transaction. The new merchant may he similar to previously visited merchants and recommended by the system to the account holder.

Mapping module 108 may provide capabilities or tools to customize the map associated with the account. For example, mapping module 108 may enable modifying characteristics of the indicator such as color, size, shape, annotation, text and the like, of the indicator based on various parameters. A few non-limiting examples of parameters are described below.

Mapping module 108 may set characteristics of the indicator based on transaction status of the financial transactions. In one embodiment, the characteristic of the indicator may be color. For example, mapping module 108 may set the color of a push pin on the map as red to represent an unfinished transaction and green to represent a completed transaction. In another embodiment, the characteristic of the indicator may be a size. In yet another embodiment, the characteristic of the indicator may be a shape. In a further embodiment, the characteristic of the indicator may be a combination of color, shape and/or size. Other characteristics of the indicator are also contemplated herein. In one embodiment, mapping module 108 may have default settings for modifying the characteristics of the indicator. In another embodiment, the account holder may control the settings for modifying characteristics of the indicator.

Mapping module 108 may also set a characteristic of the indicator based on transaction amount. For example, mapping module 108 may set the indicator with a red flashing color to indicate transaction amount exceeding a predefined threshold. The predefined threshold may be defined by the account holder. In another example, mapping module 108 may set the indicator with a smaller size to indicate that the transaction amount is below a predetermined threshold. Furthermore, mapping module 108 may scale the indicator size based on the transaction amount. Mapping module 108 may also set a characteristic of the indicator based on frequency of transactions. For example, the account holder may frequently transact with few merchants as compared to other merchants. In such cases, mapping module 108 may set characteristics, such as unique shapes, as the indicators pointing to the particular merchant. For example, the indicator may be squares if the frequency of transactions associated with a particular merchant crosses a predefined threshold and the indicator may he circles if the frequency of transactions is below the predefined threshold. Transaction frequency may be visually conveyed to the account holder by other ways as well.

In various embodiments, mapping module 108 may also set a characteristic of the indicator based on a transaction date. For example, mapping module 108 may use color codes for the indicator to represent transactions of different dates. Similarly, mapping module 108 may also set a characteristic of the indicator based on transaction weeks, transaction month and the like. Mapping module 108 may also set a characteristic of the indicator based on transaction time. For example, mapping module 108 may define different sizes for the indicator to represent transactions of different times. For example, more recent transactions may correspond to larger indicators.

Further, mapping module 108 may set the characteristic of the indicator based on transaction type. The transaction type may be at least one of food, services, clothing, shopping, health, fitness, business, transportation, and financial. Mapping module 108 may set different colors, different sizes, and/or different shapes for different transaction types. For example, mapping module 108 may indicate transactions of type “food” with green squares, whereas the transactions of type “services” may be indicated with blue circles. Mapping module 108 may also set the characteristic of the indicator based on discount percentage or a discount amount of the discount.

Mapping module 108 may alter the characteristic of the indicator based on the distance of the transaction location from an address of the account holder associated with the account. Mapping module 108 may receive the address or the demographic details of the account holder from processing module 106. Alternatively, mapping module 108 may retrieve address of the account holder from account module 104. The address as discussed herein may be a residential address or a workplace address or areas of frequent transactions or any address associated with the account holder that can be used as a reference relative to which the characteristic of the indicator can be altered.

In various embodiments, processing module 106 may track transactions of the account holder in reference to the account holder address, in one embodiment, processing module 106 may set distance threshold based on the tracking. In another embodiment, processing module 106 may set distance threshold based on the account holder instruction. If any transaction occurs beyond the threshold distance, processing module 106 may alert the account holder. In one embodiment, the alert may be displayed in conjunction with the indicator in the map. In another embodiment, the alert may be in a form of for example, a text message, and/or an email,

Moreover, mapping module 108 may present the map comprising the indicator and the transaction data to the account holder. In one embodiment, mapping module 108 may present the transaction data relative to the indicator. In another embodiment, mapping module 108 may hide the transaction data. The transaction data may be displayed when the account holder hovers a pointer device over the indicator, for example. Other ways of presenting the transaction data in the map are also contemplated herein. Mapping module 108 may provide options in a user interface to enable the account holder to customize the presentation of the map and indicators. In one embodiment, mapping module 108 may provide filters on the user interface to enable the account holder to display indicators based on a transaction status of the financial transactions, a transaction amount, a frequency of transactions, the transaction date, the transaction time, the transaction type, and/or the like. For example, the account holder may set a filter for mapping module 108 to provide indicators associated with transaction amount greater than the account holder provided value. Mapping module 108 may present indicators associated with transaction amount that are greater than the account holder provided value.

In various other embodiments, the transaction data may also he presented without a map. Processing module 106 may present the transaction data in an interface, if the account holder requests for non-map based presentation. Processing module 106 may provide an interface with various options for the account holder to customize the organization and presentation of the transaction data. The account holder may use the options request the processing module 106 to present the transaction data based on transaction status, transaction amount, frequency of transaction, transaction date, transaction time, and/or transaction type, processing module 106 may organize a plurality of the financial transactions according to the account holder request. In one embodiment, processing module 106 may also organize data automatically.

In various embodiments, mapping module 108 may further enable the account holder to share the map to the account holder's website, social networking site, merchant websites, and the like. In one embodiment, mapping module 108 may automatically share the map to the account holder's website, social networking site, external websites and/or the like. In another embodiment, mapping module 108 may share the map based on the instruction from the account holder. Mapping module 108 may filter sensitive data such as the account number, the transaction amount, etc., of the transaction data while sharing the map. Mapping module 108 may filter the sensitive data to prevent the sharing of the sensitive information that can be misused by viewers. Mapping module 108 may also filter subset of transaction data to be displayed based on the account holder instruction.

Mapping module 108 may also enable the account holder to provide reviews on the merchant and/or the merchant offerings. In one embodiment, mapping module 108 may provide an option such as a functional button in conjunction with the indicator which when used, generates an interface to provide an input review. Mapping module 108 may receive the input review and generate the review request. The review request may include the account holder review. In response to the request, mapping module 108, in one embodiment, may communicate the request to processing module 106. Processing module 106 may determine that the account holder has a financial transaction at the merchant on a particular date by analyzing the transaction data. Processing module 106 may communicate a result of determining the financial transaction to mapping module 108. In another embodiment, mapping module 108 may determine that the account holder has a financial transaction at the merchant on the particular date by analyzing the transaction data. Processing module 106 or mapping module 108 may generate a transaction certificate certifying that the account holder has performed the financial transaction with the merchant. Mapping module 108 may send the certified account holder review to at least one of a social network or any website instructed by the account holder. The certified account holder review may include the review request and the transaction certificate. The certified account holder review further includes the date of the financial transaction by the account holder at the merchant.

Transaction module 100 may further include an authorization module (not shown) to authorize the account holder to access the account, transaction data, and the map through transaction module 100. The account may be accessed through a web browser and/or interfaces of a stand-alone application. On authorization, processing module 106 may enable the account holder to view and/or modify the account details. Processing module 106 may enable the account holder to access and/or view the account transactions in non-map interface. Processing module 106 may provide options to the account holder to access, view, and modify the account related information. Processing module 106 may also provide options to view the transactions in the map view.

Although, transaction module 102 is discussed as managing one account, it may be appreciated that the transaction module 102 is capable of managing multiple accounts. In such cases, the account holder may select one of the multiple accounts to view the geographically mapped transactions. Transaction module 102 may also be capable of displaying the geographically mapped transactions corresponding to the multiple accounts on a single map.

In one embodiment, transaction module 102 as described herein may be a computer-based system. In another embodiment, transaction module 102 may be a component that can be implemented in computer-based systems such as, for example, a server, any suitable personal computer, a mobile device, a personal data assistant (PDA), a network computer, a workstation, a minicomputer, a mainframe or the like. In yet another embodiment, transaction module 102 may also be an independent component made of hardware, software, or hardware and software that can be implemented in or in conjunction with the computer-based systems. Those skilled in art can appreciate that computer-based system includes an operating system (e.g., Windows NT, 95/98/2000, OS2, UNIX, Linux, Solaris, MacOS, etc.) as well as various conventional support software and drivers typically associated with server/computer. Transaction module 102 as described herein may be deployed the account provider. The account provider may be a financial institution, issuer, a merchant and/or or a third-party.

In a further embodiment, transaction module 102 can be implemented as a set of computer related instructions. The computer readable instructions of corresponding modules and tools may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

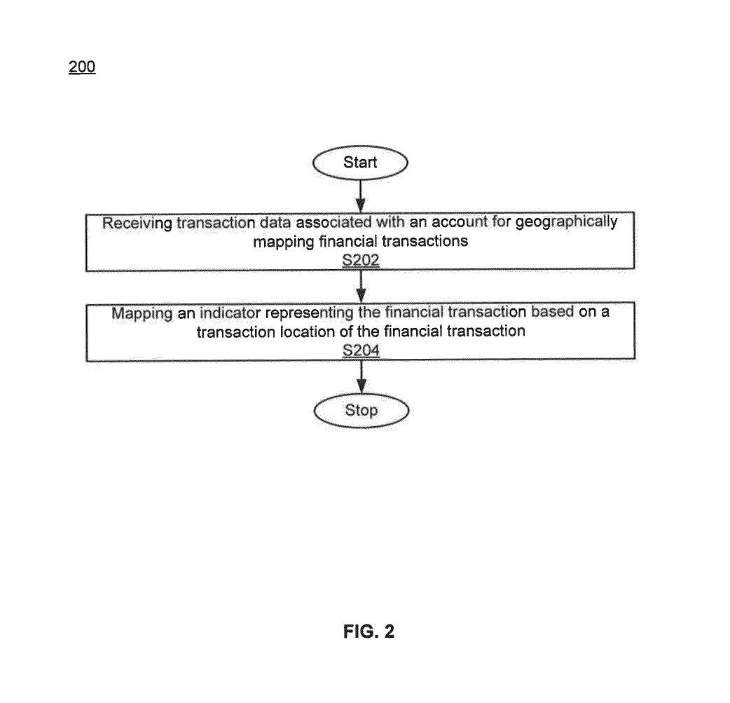

FIG. 2 is a flowchart of an exemplary process 200 for geographically mapping transactions, according to one embodiment. In step S202, transaction module 102 receives transaction data associated with an account for geographical mapping. The transaction data may include data associated with a financial transaction performed with a merchant using the account. Transaction module 102 may determine a public name of the merchant, a transaction location representing location of the financial transaction, financial transactions information including transaction amount, discounts, and the like, by processing the transaction data. Transaction module 102 may use the public name of the merchant, the transaction location, the financial transaction information to map the financial transaction to a map. Transaction module 102, in step S204, maps an indicator representing the financial transaction based on the transaction location of the financial transaction. A subset or full transaction data may be displayed relative to the indicator.

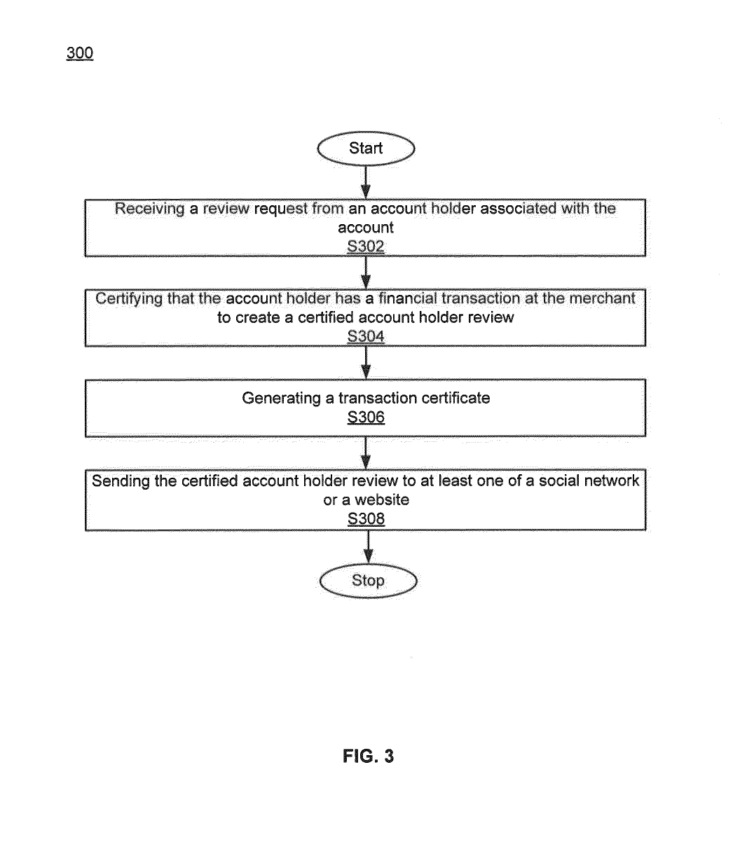

Transaction module 102 may also provide an option for the account holder to input review. Further, transaction module 102 may enable the account holder to share the review to one or more external websites. FIG. 3 is a flowchart of an exemplary process 300 for sharing the account holder review to external websites, according to one embodiment. In step S302, transaction module 102 may receive the review request from an account holder associated with the account. The review request may include an account holder review of the merchant and/or merchant offerings associated with the transaction. On receiving the review request, transaction module 102, in step S304 may certify that the account holder has the financial transaction at the merchant to create a certified account holder review. In step S306, transaction module 102 may generate a transaction certificate,

In step S308, transaction module 102 may send the certified account holder review to at least one of a social network or a website. For example, the computer-based system may send the account holder review associated with the merchant and/or the merchant offering to the account holder's portal in the social network or the website. The certified account holder review may include the review request and the transaction certificate. The account holder's review may be published in the account holder's portal or in the website.

The steps are presented for the sake of explanation only and are not intended to limit the scope of the disclosure in any way.

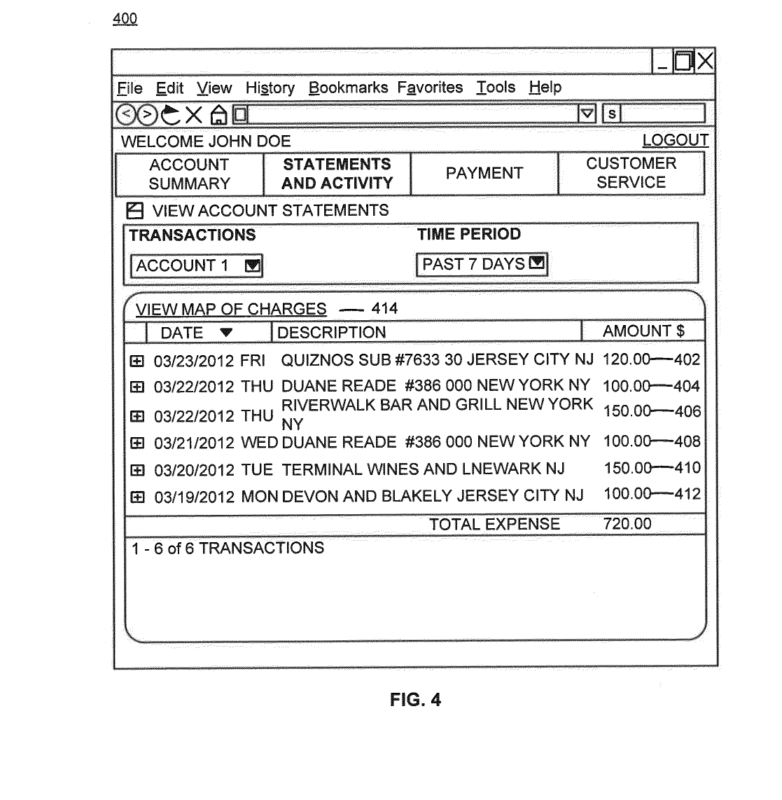

An example is now provided herein to describe the functioning of transaction module 102. FIG. 4 is an exemplary user interface view 400 illustrating an account statement of an account holder John Doe, according to various embodiments. User interface view 400 illustrates various options such as account summary, statements and activity, payment and customer service. The account summary option may enable John Doe to view important details of the account. The details may include an account number, an account balance, a credit balance, rewards, financial institution issuing the account and the like. The statements and activity option enables John Doe to view account statements, retrieve account statements, view activities in the account and the like. The term “statement” refers to summary of transactions. The term “activities” refer to transactions such as amount credited, amount debited, interest on the amount, etc. associated with the account. The payment option may enable John Doe to make payments such as money transfer, bill payments, premium payments and the like. The customer service option may enable John Doe to send an email, a text message, and chat with customer service regarding any communications. The customer service option may also provide contact numbers and addresses regarding account related communications.

In the current example, the statements and activity option is selected. The user interface view 400 illustrates transactions drop down box and time period drop down box, John Doe can select the options in the dropdown boxes. In current example, John Doe has selected account 1 in the transactions drop down box and time period as past seven days in time period drop down box. Such selections may generate a request for account statement for past seven days. Response to the request, transaction module 102 may be an account statement showing transaction activity of past 7 days.

Activity 402 represents transaction with “Quiznos Sub” on date Mar. 23, 2012 (Friday). Activity 404 represents transaction with “Duane Reade” on date Mar. 22, 2012 (Thursday). Activity 406 represents transaction with “Riverwalk bar and grill sandwich” on date Mar. 22, 2012 (Thursday) and so on.

User interface view 400 also illustrates a “view map of charges” option 414. View map of charges option 414 enables John Doe to see the transactions geographically mapped onto a map. Upon selecting the on “view map of charges” option 414, transaction module may obtain merchant name, merchant address associated with the transactions, transaction locations, transaction amounts, transaction dates and/or other transaction information in the transaction data associated with activities 402-412. Transaction module 102 may generate indicators associated with the transactions. Further, transaction module 102 may map indicators that represent transactions into the map. Transaction module 102 may also provide transaction merchant name, merchant address associated with the transactions, transaction locations, transaction amounts, transaction dates and/or other transaction information relative to the corresponding indicators.

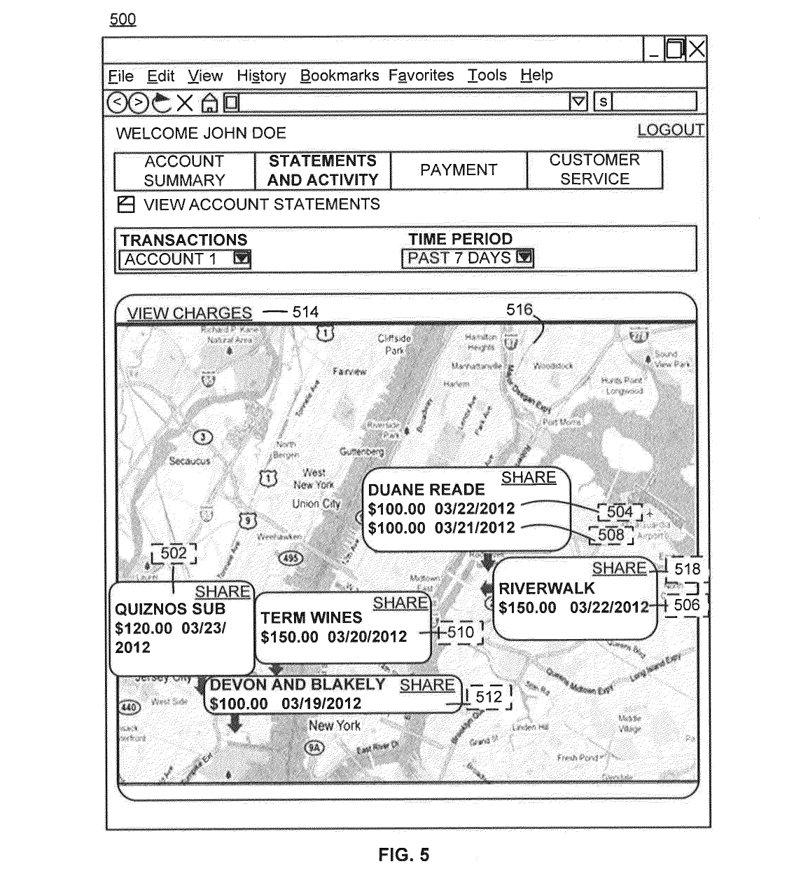

FIG. 5 is an example user interface view 500 illustrating a map 51.6 on which indicators representing the transactions are mapped, according to various embodiments. In the various embodiments, activities 402-412 that represent various transactions are mapped into map 416 as indicators 502-512. Each activity representing a transaction is mapped as an indicator. In various examples, the indicator is a location arrow with a text box providing a portion of the transaction data. FIG. 5 also illustrates “view charges” option 514 that enables John Doe to switch from map mode to activities view mode.

With continued reference to FIG. 5, an indicator 502 associated with transaction related to Quiznos Subway sandwiches is mapped to a corresponding location in Jersey City of map 516. Indicator 502 indicates that a transaction was performed in Quiznos Subway sandwiches amounting to $120 on Mar. 23, 2012. Similarly, indicators 504 and 508 associated with transaction related to Duane Reade drug store are mapped to a corresponding location in New York City in map 516 as illustrated in FIG. 5. Indicators 504 and 508 indicate that two transactions of $100 each were performed at Duane Reade drug store on Mar. 22, 2012 and Mar. 21, 2012, respectively. Indicator 506 indicates that a transaction was performed in Riverwalk bar and grill amounting $150 on Mar. 23, 2012. Similarly, indicators 510 and indicator 512 indicate that transactions were performed in Terminal wines and Lnewark, and Devon and Blakely, respectively.

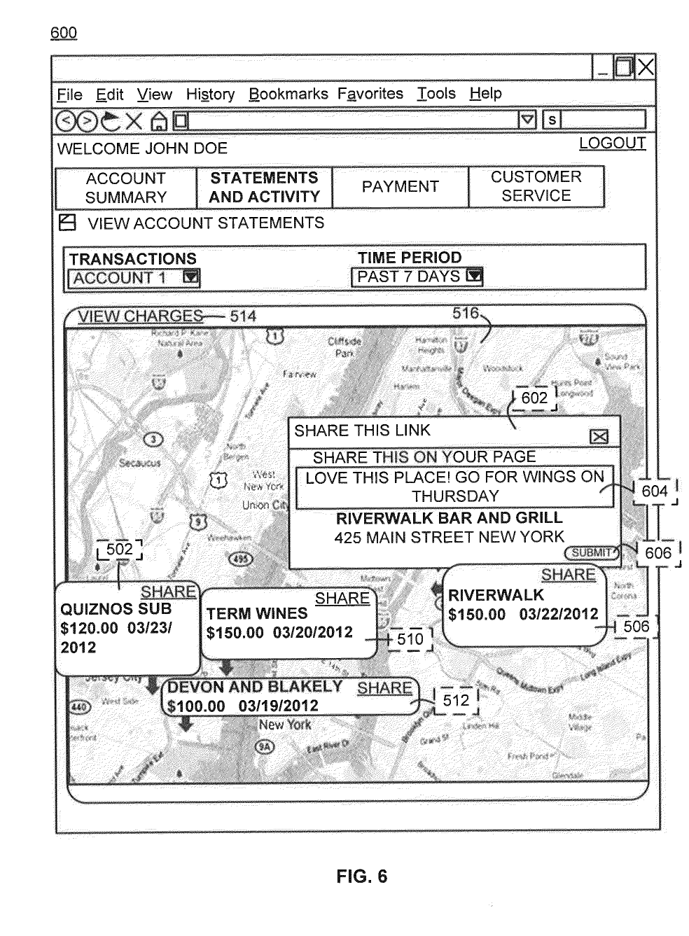

It can be seen that each of the indicators has a share option. The share option enables John Doe to provide a review of the corresponding merchant, and/or a merchant offering. An example user interface view illustrating receiving John Doe's opinion is illustrated in FIG. 6.

On using the share option, transaction module 102 may provide an interface, such as, an interface 602 to input the review. The interface may be a popup, a text box or a separate webpage. The interface may include merchant name, merchant address and/or other merchant related information. Alternatively, or in addition, the interface may include details about the merchant offerings. The interface may further include a text field, such as, a text field 604, where the account holder can enter the review. The interface may also include a submit option (for example, a submit button 606) to enable the account holder to share the review on a social networking site, or any online space of the account holder's choice.

In the current example, John Doe has used a share option (for example 518 of FIG. 5) associated with an indicator representing transaction at Riverwalk bar and grill. In response to using the share option (for example, through clicking), transaction module 102 has provided a text box 604 for John Doe to input review. John Doe may input his review as “Love this place! Go for wings on Thursday” in text box 604. John Doe may use a submit option 606 in the text box to share the review on a personal portal of a social networking site, website, and/or on any online space of John Doe's choice.

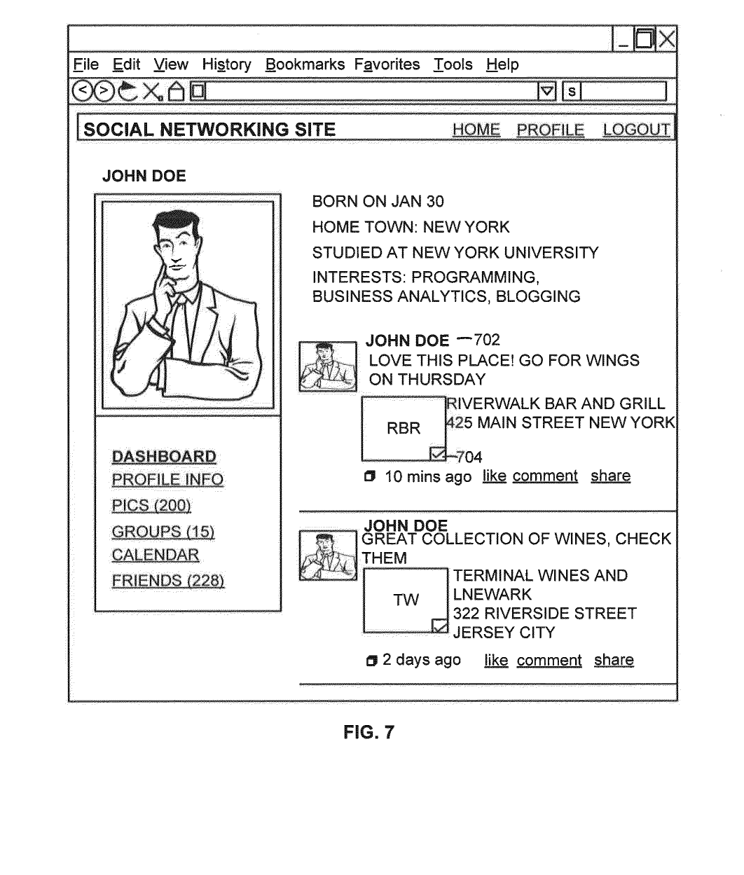

In accordance with various embodiments, FIG. 7 is a user interface view 700 illustrating John Doe's personal portal of a social networking site. Examples of the social networking sites may include Facebook®, Twitter®, Flickr®, Foursquare®, Pinterest™, LinkedIn®, etc. The personal portal may show the personal details of John Doe such as birth date, home town, education details, and interests. The personal portal also provides links to dashboard, profile information, pictures, groups, calendar, and friends. The current example shows the dashboard having updates and posts. Post 702 is a review shared from the map to the dashboard as a result of using the share option. Post 702 includes a profile picture, the review, posting time, a “like” option, comment option and share option. The review may further include the merchant information (such as merchant logo, merchant name and address). The review may also include transaction details, such as, the transaction date. In addition, the review may include an indicator indicating that a transaction certificate is associated with the review. Also, an indication 704 is provided to indicate that the user has performed a verified transaction with the merchant and is a certified reviewer.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in Which reference to an element in the singular is not intended to mean “one and only one” unless explicitly so stated, but rather “one or more.” Moreover, where a phrase similar to at least one of A, B, and C′ or at least one of A, B, or C′ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

The present disclosure (i.e., transaction module 102, process 200, process 300, any part(s) or function(s) thereof) may be implemented using hardware, software or a combination thereof, and may be implemented in one or more computer systems or other processing systems. However, the manipulations performed by the present disclosure were often referred to in terms, such as comparing or checking, which are commonly associated with mental operations performed by a human operator. No such capability of a human operator is necessary, or desirable in most cases, in any of the operations described herein, which form a part of the present disclosure. Rather, the operations are machine operations. Useful machines for performing the operations in the present disclosure may include general-purpose digital computers or similar devices.

In fact, in accordance with an embodiment of the present disclosure, the present various embodiments are directed towards one or more computer systems capable of carrying out the functionality described herein,

Computer system 800 includes at least one processor, such as a processor 802. Processor 802 is connected to a communication infrastructure 804, for example, a communications bus, a cross over bar, a network, and the like. Various software embodiments are described in terms of this exemplary computer system 800. After reading this description, it will become apparent to a person skilled in the relevant art(s) how to implement the present embodiments using other computer systems and/or architectures.

Computer system 800 includes a display interface 806 that forwards graphics, text, and other data from the communication infrastructure 804 for display on a display unit 808.

Computer system 800 further includes a main memory 810, such as random access memory (RAM), and may also include a secondary memory 812. Secondary memory 812 may further include, for example, a hard disk drive 814 and/or a removable storage drive 816, representing a floppy disk drive, a magnetic tape drive, an optical disk drive, etc. Removable storage drive 816 reads from and/or writes to a removable storage unit 818 in a well known manner. Removable storage unit 818 may represent a floppy disk, magnetic tape or an optical disk, and may be read by and written to by removable storage drive 816. As will be appreciated, removable storage unit 818 includes a computer usable storage medium having stored therein, computer software and/or data.

In accordance with various embodiments, secondary memory 812 may include other similar devices for allowing computer programs or other instructions to be loaded into computer system 800. Such devices may include, for example, a removable storage unit 820, and an interface 822. Examples of such may include a program cartridge and cartridge interface (such as that found in video game devices), a removable memory chip (such as an erasable programmable read only memory (EPROM), or programmable read only memory (PROM)) and associated socket, and other removable storage unit 820 and interfaces 822, which allow software and data to be transferred from removable storage unit 820 to computer system 800.

Computer system 800 may further include a communication interface 824. Communication interface 824 allows software and data to he transferred between the computer system 800 and external devices. Examples of communication interface 824 include, but may not be limited to a modem, a network interface (such as an Ethernet card), a communications port, a Personal Computer Memory Card International Association (PCMCIA) slot and card, and the like. Software and data transferred via the communication interface 824 are in the form of a plurality of signals, hereinafter referred to as signals 826, which may be electronic, electromagnetic, optical or other signals capable of being received by the communication interface 824. Signals 826 are provided to communication interface 824 via a communication path (e.g., channel) 828. Communication path 828 carries signals 826 and may be implemented using wire or cable, fiber optics, a telephone line, a cellular link, a radio frequency (RF) link and other communication channels,

In this document, the terms “computer program medium” and “computer usable medium” are used to generally refer to media such as removable storage drive 816, a hard disk installed in hard disk drive 814, signals 826, and the like. These computer program products provide software to computer system 800. The various embodiments may be directed to such computer program products.

Computer programs (also referred to as computer control logic) are stored in main memory 810 and/or secondary memory 812. Computer programs may also be received via the communication infrastructure 804. Such computer programs, when executed, enable computer system 800 to perform the features of the various embodiments, as discussed herein. In particular, the computer programs, when executed, enable processor 802 to perform the features of the various embodiments. Accordingly, such computer programs represent controllers of computer system 800.

In accordance with various embodiments, where the embodiments are implemented using a software, the software may be stored in a computer program product and loaded into computer system 800 using the removable storage drive 816, hard disk drive 814 or communication interface 824. The control logic (software), when executed by processor 802, causes processor 802 to perform the functions as described herein,

In another embodiment, the various embodiments are implemented primarily in hardware using, for example, hardware components such as application specific integrated circuits (ASIC). Implementation of the hardware state machine so as to perform the functions described herein will be apparent to persons skilled in the relevant art(s). In yet another embodiment, the various embodiments are implemented using a combination of both the hardware and the software.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e,g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as Such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of Which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may he implemented as other types of networks, such as an interactive television (ITV) network. Moreover, the system contemplates the use, sale or distribution of any goods, services or information over any network having similar functionality described herein.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

“Cloud” or “Cloud computing” includes a model for enabling convenient, on-demand network access to a shared pool of configurable computing resources (e.g., networks, servers, storage, applications, and services) that can he rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

While various embodiments have been described above, it should be understood that they have been presented by way of example, and not limitation. It will be apparent to persons skilled in the relevant art(s) that various changes in form and detail can be made therein without departing from the spirit and scope of the present disclosure. Thus, the present disclosure should not be limited by any of the above described exemplary embodiments, but should be defined only in accordance with the following claims and their equivalents.

In addition, it should be understood that the figures illustrated in the attachments, which highlight the functionality and advantages of the various embodiments, are presented for example purposes only. The architecture of the various embodiments are sufficiently flexible and configurable, such that it may be utilized (and navigated) in ways other than that shown in the accompanying figures.

For the sake of brevity, conventional data networking, application development and other functional aspects of the systems may not be described in detail herein. Furthermore, the connecting lines shown in the various figures contained herein are intended to represent exemplary functional relationships and/or physical couplings between the various elements, it should he noted that many alternative or additional functional relationships or physical connections may be present in a practical system.

The present disclosure is described herein with reference to block diagrams and flowchart illustrations of methods, and computer program products according to various aspects of the disclosure. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may be present in any number of configurations including the use of windows, web pages, hypertexts, hyperlinks, web forms, popup windows, prompts and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

1. A method comprising:
receiving, by a computer-based system for geographically mapping financial transactions, transaction data associated with an account and in response to the financial transaction being initiated, wherein the transaction data is associated with a financial transaction;
mapping, by the computer-based system, on a map an indicator representing the financial transaction based on a transaction location of the financial transaction;
requesting, by the computer-based system, a comment in response to the mapping of the indicator; and
modifying, by the computer-based system, the indicator to include at least of portion of the comment.

2. The method of claim 1, further comprising authorizing, by the computer-based system, an account holder with the account to view the map.

3. The method of claim 1, further comprising setting, by the computer-based system, a characteristic of the indicator based on a transaction status of the financial transaction.

4. The method of claim 1, further comprising setting, by the computer-based system, a characteristic of the indicator based on at least one of a transaction status, transaction amount, frequency, transaction date, and transaction time.

5. The method of claim 4, further comprising altering, by the computer-based system, the characteristic on the indicator based on the distance of the transaction location from an address of an account holder associated with the account.

6. The method of claim 1, further comprising:
correlating, by the computer-based system, merchant data with the transaction location, wherein an invoice address of the merchant data is not the same as the transaction location, and wherein the transaction location is determined using an address or latitude-longitude coordinates; and
associating, by the computer-based system, the merchant data with a public name of a merchant.

7. The method of claim 1, further comprising setting, by the computer-based system, a characteristic of the indicator based on transaction type, and wherein the transaction type is at least one of food, services, clothing, shopping, health, fitness, business, transportation, and financial.

8. The method of claim 1, further comprising alerting, by the computer-based system, an account holder associated with the account, in response to the transaction location exceeding a predetermined distance from at least one of the address of the account holder or areas of frequent transactions.

9. The method of claim 1, further comprising:
filtering, by the computer-based system, the transaction data based on an attribute of the transaction data, wherein the attribute of the transaction data includes at least one of transaction amount, merchant, transaction type, transaction date, transaction time, and transaction location; and
displaying, by the computer-based system, at least a subset of the transaction data on the indicator.

10. The method of claim 1, further comprising retrieving, by the computer-based system, account holder data associated with an account holder, based on the account holder being associated with the account, wherein the account holder data includes an account number, an account holder address, and demographic information of the account holder.

11. The method of claim 1, wherein the computer-based system is one of a personal computer or a mobile device.

12. The method of claim 1, further comprising:
modifying, by the computer-based system, the indicator to provide discount information in response to the transaction including a discount; and
modifying, by the computer-based system, a characteristic of the indicator based on a discount percentage or a discount amount of the discount.

13. The method of claim 1, further comprising displaying, by the computer-based system, at least one of a discount offer.

14. The method of claim 13, further comprising populating, by the computer-based system, the discount offer based on a merchant location of a merchant offering the discount relative to the transaction location.

15. The method of claim 13, further comprising populating, by the computer-based system, the discount offer based on a prior transaction at a merchant offering the discount.

16. The method of claim 1, further comprising:
receiving, by the computer-based system, a review request from an account holder associated with the account;
certifying, by the computer-based system, that the account holder has a financial transaction at the merchant to create a certified comment;
generating, by the computer-based system, a transaction certificate; and
sending, by the computer-based system, the comment to at least one of a social network or a website.

17. The method of claim 16, wherein the certified comment further includes a date of the financial transaction by the account holder at the merchant.

18. The method of claim 1, further comprising organizing, by the computer-based system, a plurality of the financial transactions according to a transaction status.

19. An article of manufacture including a non-transitory, tangible computer readable storage medium having instructions stored thereon that, in response to execution by a computer-based system for geographically mapping financial transactions, cause the computer-based system to perform operations comprising:
receiving, by the computer-based system, transaction data associated with an account and in response to the financial transaction being initiated, wherein the transaction data is associated with a financial transaction;
mapping, by the computer-based system, on a map an indicator representing the financial transaction based on a transaction location of the financial transaction;
requesting, by the computer-based system, a comment response to the mapping of the indicator; and
modifying, by the computer-based system, the indicator to include at least of portion of the comment.

20. A system comprising:
a processor for geographically mapping financial transactions,
a tangible, non-transitory memory communicating with the processor,
the tangible, non-transitory memory having instructions stored thereon that, in response to execution by the processor, cause the processor to perform operations comprising:
receiving, by the processor, transaction data associated with an account and in response to the financial transaction being initiated, wherein the transaction data is associated with a financial transaction;
mapping, by the processor, on a map an indicator representing the financial transaction based on a transaction location of the financial transaction;
requesting, by the processor, a comment in response to the mapping of the indicator; and
modifying, by the processor, the indicator to include at least of portion of the comment.
